(19) United States
(12) Patent Application Publication
(10) Pub. No.: US 2004/0262940 A1
(43) Pub. Date: Dec. 30, 2004

(54) Small driverless passenger vehicles and systems, and methods for using such vehicles

(76) Inventor: Robert E. Johnson, Baltimore, MD (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/754,558

(22) Filed: Jan. 12, 2004

Related U.S. Application Data
(60) Provisional application No. 60/438,984, filed on Jan. 10, 2003.

(51) Int. Cl. B60N 2/00

(52) U.S. Cl. 296/64

(57) ABSTRACT

Small driverless passenger vehicles are configured to carry passengers in either a shared or private mode by having laterally facing seating stations that are spaced from one another in which adjacent seating stations have opposite orientations so that passengers are neither directly opposite, nor directly proximate, one another. The vehicles have sliding U-shaped canopies cantilevered over the vehicle floor providing ingress and egress from both sides of the vehicles. The vehicles have rear openings for ventilation, which are covered by grilles and protected from precipitation by an overhanging portion of the vehicle's roof. The vehicles are used in combination with a passenger transportation line having stations that include queues for shared vehicle use and queues for private vehicle use.

### RELATED PATENT APPLICATIONS

This application claims priority from provisional patent application No. 60/438,984, filed Jan. 10, 2003 incorporated herein in its entirety by reference.

### BACKGROUND OF THE INVENTION

1) Field of the Invention

The present invention is directed to improvements in small driverless passenger vehicles (SDPVs) and systems, and to methods for using such vehicles. More particularly, the present invention is directed to improvements which make such vehicles more passenger friendly and is directed to systems and methods for serving passengers which increase efficiency and cater to passenger sensibilities while fulfilling public needs by queuing passengers in a flexible scheme.

2. Background Art

All 3-4 passenger SDPV systems of the prior art, usually called personal rapid transit (PRT), seat riders 2-3 abreast in one or two rows. This arrangement requires passengers to sit in close proximity to one another which decreases the comfort level within the vehicle when traveling with strangers. Although existing PRT designs specify that only pre-formed groups travel together, the need to meet high peak period demand will probably result in high peak hour fares that cause informal “car pooling” by strangers.

Current PRT vehicles also have low ceilings which interfere with egress and entry of passengers. This shortcoming has been partially addressed by vehicles having sliding doors which are supported by a roof rail, however with this arrangement a passenger who enters the vehicle from a loading platform is interfered with by the roof rail and must stoop upon entry. Accordingly, there is a need for an arrangement which closes the vehicles that does not require a passenger to stoop to laterally pass beneath a roof railing in order to access a seat on the opposite side of the vehicle from the entry side. Moreover, it is desirable to facilitate entry and exit from both sides of such vehicles in order to add or maintain flexibility of the PRT system.

A number of automated passenger vehicle systems are in use throughout the world. Almost all of these consist of vehicles traveling on special guideways. In addition to providing support and lateral guidance to the vehicle, the guideway also supplies electric power which is transferred to the vehicle by means of a sliding contact. Because of the ready availability of this power, the passenger compartment is typically cooled in hot weather by conventional mechanical air conditioning.

It is also possible to have a battery powered automated passenger vehicle. This eliminates the cost and danger of the power rail in the guideway, and also reduces the necessity of the vehicle following a precise path to maintain electrical contact with the rail. A difficulty with this approach is that the limited energy storage capacity of batteries makes air conditioning less desirable.

The fact that a vehicle is automated introduces additional constraints on the design of the ventilation system for the passenger compartment. Conventional windows, such as are found in most transit buses, have a number of problems:

1. They cannot be operated by some disabled individuals.

2. They pose a hazard to small children who might travel alone in an automated vehicle. A child could easily reach through the window, or could even fall completely out of the vehicle.

3. In hot weather, passengers could open the windows for ventilation and then exit the vehicle at their destination. If the vehicle happened to stand empty and it started to rain, the rain could enter through the open windows.

With respect to current systems, PRTs systems generally assume that all vehicles are private wherein riders hire an entire vehicle to either travel alone or in preformed parties. In these arrangements, the vehicles are all automated and have 3-4 seats with all trips being non-stop from origin to destination. By having all vehicles private, the efficiency of PRT systems is compromised, especially during periods of peak demand because many vehicles which could be filled to capacity are partially empty. Thus, it is desirable to have systems which accommodate non-shared private service with shared or public service.

Starting in the 1960's, a large number of Personal Rapid Transit (PRT) systems have been proposed. These are driverless taxicabs that operate on exclusive guideways, typically elevated. None has been put into service. A system called Personal Rapid Transit operates in Morgantown, W. Va., but it uses larger, 20-passenger vehicles, and does not meet the generally accepted definition of PRT.

PRT stations are off the main line. All passengers are expected to be seated, and low headroom precludes adult standees. Except in periods of high demand, vehicles wait for passengers. Users select their destination station, and the trip is non-stop. A user always gets an entire vehicle, which may be shared by a group already traveling together. Strangers can share a vehicle if they agree among themselves to split the fare, and select one of their group to pay the fare.

If a station runs out of vehicles, a passenger queue will form. In theory, a single passenger queue is appropriate because all vehicles entering a station are equivalent since they either are, or will become empty.

PRT interior layouts are mostly: a) three seats abreast, or b) four seats with two seats abreast facing forward and two other seats facing backwards, arranged so the passengers riding backwards face those riding forward. In the four-seat layouts, the two rear-facing seats fold up to accommodate a wheelchair. The three-seat layouts use the floor in front of the seats for a wheelchair.

### SUMMARY OF THE INVENTION

The present invention is directed to a small driverless passenger vehicle having a floor with a directional axis, the floor being supported on an array of wheels for conveying the vehicle over a surface. A canopy is disposed above the floor and cooperates with the floor to define an enclosure in which passengers are seated. A seating arrangement is disposed within the enclosure, the seating arrangement having at least three laterally extending seating zones. A single seating station is disposed at each seating zone for seating a passenger facing laterally with respect to the directional axis of the floor. The seating stations in adjacent seating zones facing in opposite lateral directions, providing unobstructed floor space in front of each seating station and providing a space in the direction of the directional axis between upper bodies of adjacent passengers.

In a further aspect of the invention, each seating station of the vehicle includes a seat defined by a horizontal surface wherein at least one of the seats folds to a vertical orientation providing additional floor space.

In another aspect of the invention, the vehicle further includes horizontal supports for the canopy, the supports extending parallel to the directional axis for mounting the canopy to slide from a closed position, overlying all of the folding seating stations, to an open position, exposing the folding seating stations.

In a further aspect of the invention, the canopy is U-shaped in cross section and has leg panels with free edges that are supported on the horizontal supports. The canopy may have portions which are transparent. When in the open position the canopy allows ingress and egress from opposite sides of the vehicle.

In still a further aspect of the invention, the vehicle includes a rear surface having a vent therethrough.

In still a further aspect of the invention, the vent in the rear surface is adapted to receive a removable window and an optionally removable grill.

In still another aspect of the invention, the vehicle includes an electric fan in the front of the vehicle for generating an air stream through the vehicle.

In a further aspect of the invention the vehicle is in combination with a fleet of similar vehicles each providing both shared and private seating (although not at the same time), the combination including a main line over which the vehicles travel to carry passengers from one station to another, wherein each station comprises a shared service area for passengers willing to share a ride with strangers; a private service area for passengers deciding not to share rides with strangers; and a vehicle queuing area for arriving vehicles.

In additional aspects of the invention, a method of operating a transit system, comprising providing a fleet of small driverless vehicles wherein each vehicle has at least three seating stations that do not directly face one another and which face in alternate directions from opposite sides of the vehicles. The method further comprises providing a transportation line having at least two stations from which the vehicles start and stop when carrying passengers therebetween. The method further provides for queuing passengers who are willing to share rides with other passengers in at least one line at a shared service location and queuing passengers who prefer not sharing rides with strangers in at least one line at a private service location.

In other aspects of the method there are a number of stations, wherein when any one of the vehicles arrives at a shared service area at one of the stations, all riding passengers exit the vehicle. Then the first waiting passenger in the line selects a destination just prior to entering the vehicle. The method further including notifying other passengers in the line of the selected destination and advancing passengers in the line going to the selected destination past passengers going to other destinations for boarding the vehicle to the destination selected by the first waiting passenger.

In still other aspects of the method, other passengers in the shared service line exercise the option to enter the vehicle even if the destination selected by the first waiting passenger is an initial destination, rather than a desired destination of other passengers; wherein upon arrival at the initial destination, the other passengers exercise the option of then boarding either a vehicle in the private service area or in the shared service area to take another vehicle to their desired destination.

### BRIEF DESCRIPTION OF THE DRAWINGS

FIG. 1 is a perspective view of a prior art four passenger vehicle;

FIG. 2 is a schematic view, in perspective, showing a floor plan for a four passenger PRT vehicle having two folded seats and two unfolded seats;

FIG. 3 is a view similar to FIG. 2, but showing a four passenger vehicle with all four seats unfolded;

FIG. 4 is a view similar to FIGS. 2 and 3 of an SDPV with three seats, two of which are folded;

FIG. 5 is a perspective view of the SDPV of FIG. 4 showing all three seats unfolded;

FIG. 6 is a side view of the SDPV with a cantilevered canopy in an open position for entry and egress;

FIG. 7 is a side view of the vehicle of FIG. 6 showing the canopy closed;

FIG. 8 is a side schematic view of the cantilevered canopy showing the canopy in the closed position;

FIG. 9 is a side schematic view similar to FIG. 8, but showing the cantilevered canopy in the open position;

FIG. 10 is an elevational view taken along lines 10-10 of FIG. 9;

FIG. 11 is an a elevational view taken along lines 11-11 of FIG. 9;

FIG. 12 is a front view of the sliding canopy disclosed in FIGS. 6-11 with parts omitted for clarity;

FIG. 13 is a schematic view of a boarding and alighting station for a fleet of SDPVs having both public service and private service passengers;

FIG. 14 is a top view similar to FIG. 13 showing passenger queues and signage associated with the arrangement of FIG. 13.

FIG. 15 is a side view of a vehicle according to the present invention provided with a ventilation system, and

FIG. 16 is a rear view of the vehicle of FIG. 15.

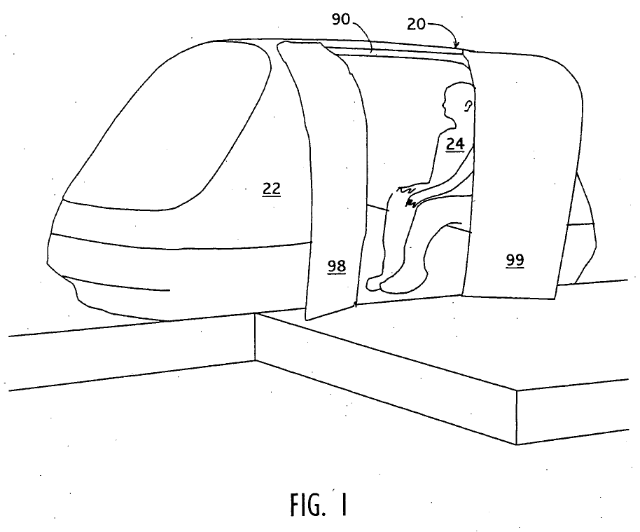

### FIGS. 1-5 IMPROVED SEATING ARRANGEMENT

Referring now to FIG. 1 there is shown a typical prior art seating arrangement 20 for a PRT vehicle 22 wherein 4 passengers 24 face either toward the direction of travel or away from the direction of travel. In the prior art arrangement of FIG. 1, the passengers face one another and sit directly next to one another, compromising privacy if strangers should travel together.

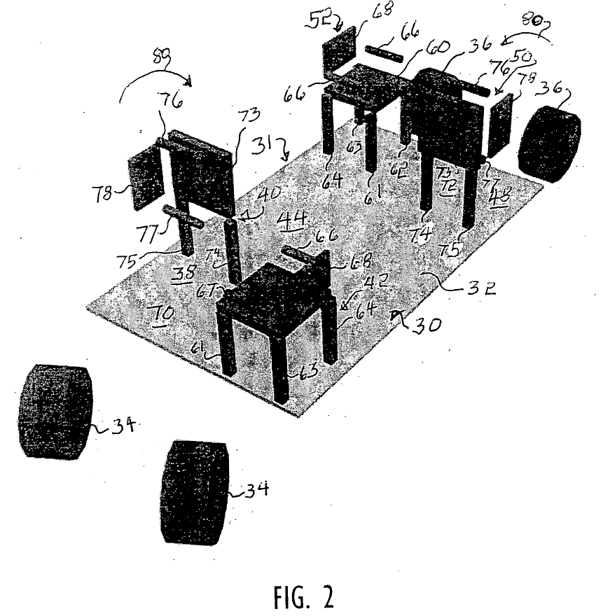

In FIGS. 2-5, a seating arrangement 30 is shown according to the present invention fro a small driverless passenger (SDP) vehicle 31 wherein all passengers face laterally with respect to direction of travel with none of the passengers facing another passenger directly. This arrangement provides open space to the side and front of each passenger.

In the schematic arrangement of FIG. 2 a vehicle floor 32 having a directional axis 33 is supported by a pair of front wheels 34 and a pair of rear wheels 36. In a front zone 38 portion of the vehicle floor 32 there are a pair of front seating stations 40 and 42, wherein at least one of the front seating stations is foldable to an upright configuration. As is shown in FIG. 2 it is preferable to fold only seating station 40 which is positioned adjacent a central aisle zone portion 44 of the floor 32. This arrangement at least initially provides the front part of a relatively wide, laterally extending aisle to accommodate a wheel chair or space for accommodating packages, luggage or other items. Seating station 42 is preferably permanently in the deployed position, however in another embodiment of the invention the seating station 42 could be folded in a manner similar to the seat 40 to provide more floor space.

In the rear zone 48 of the platform 32 there are two rear seating stations 50 and 52, with the rear seating station 50 positioned adjacent to the central aisle 44 and the seating station 52 positioned behind and laterally spaced from the rear seating station 50. Like the front seating station 42, the rear seating station 52 is preferably not folded but is always available for seating. In another embodiment of the invention, the rear seating station 52 could also be folded.

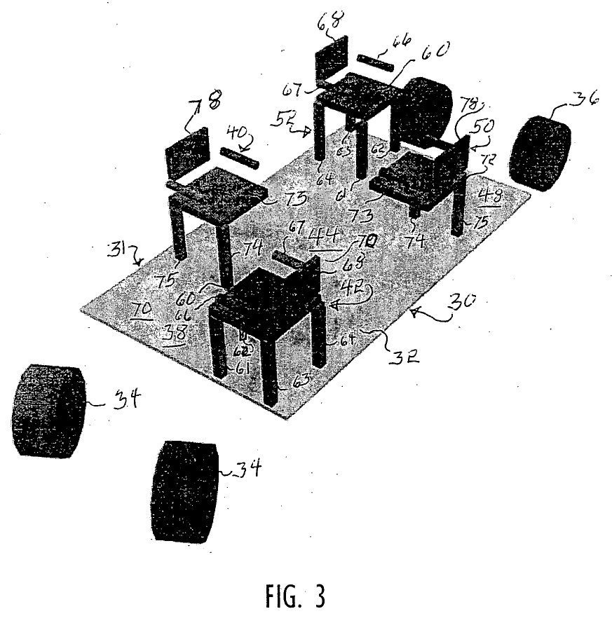

In the one possible embodiment shown in FIGS. 2 and 3, the seating stations 42 and 52 each have seats 60 supported by four legs 61, 62, 63 and 64 with the seats always in the deployed position for seating. Seats 60 further have arm rests 66 and 67 and seat backs 68. As is seen in FIGS. 2 and 3, the seating stations 42 and 52 are positioned at opposite ends of the vehicle floor 32 and face in opposite lateral directions. From the view point of a passenger in the seat station 42, there is a clear space 70 in front of the seat station as well as a clear space 72 in front of the seating section 52.

With the folding seating stations 40 and 50, seats 73 are joined to arm rests 76 and 77 and back rests 78 and are initially pivoted under the bias of a spring to extend upwardly from legs 74 and 75 on which they are mounted. The arm rests 76 and 77 as well as the back rests 78 pivot downwardly in the direction of arrows 80 with the seats 73 when the seats 73 are pivoted to a horizontal seating orientation as is shown in FIG. 3 with the arm rests and back rest oriented for seated passengers.

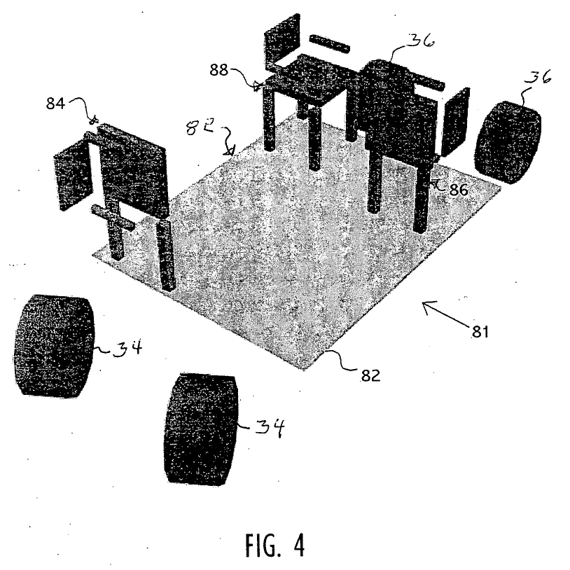

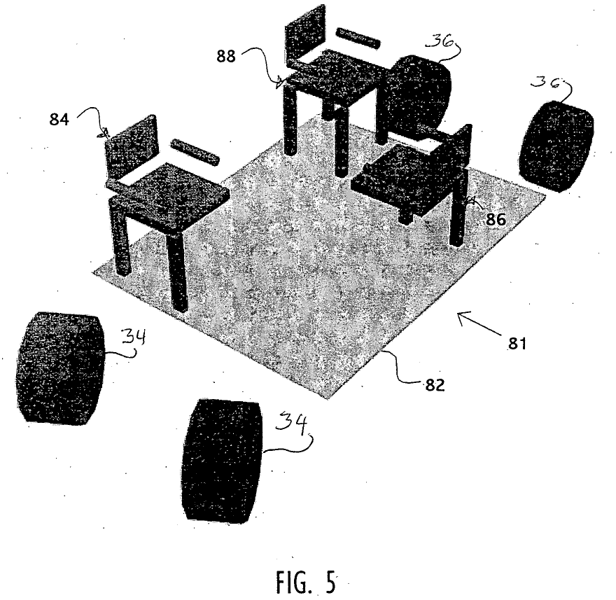

In FIG. 3, four seating stations are shown unfolded for use in the vehicle. However a vehicle can have three seating stations instead of four by omitting one of the fixed seats as is shown in FIGS. 4 and 5.

Referring now to FIGS. 4 and 5, a prototype of the seating arrangement 81 for a SDPV vehicle 82 is shown having only three seating stations 84, 86 and 88, two of which seat station (84 and 86) are folded for boarding and alighting and one of which seating station (88) remains fixed. The arm rests have not yet been installed. Preferably, the seats of the seating stations 84 and 86 are cantilevered using a spring to hold the seats folded. By having three seating stations 84, 86 and 88 instead of four, a SDPV vehicle which is substantially shorter in length is provided with each seating station having substantial room in front of the seat for leg room and for items such as luggage.

In summary, the seating layout of FIGS. 2-5 illustrates an arrangement where all passengers sit sideways with seats facing in alternating directions. Since the seat positions are staggered, passengers do not directly face each other. This provides some degree of privacy, both in terms of physical space and eye contact. In FIGS. 2 and 3, the two end seats are fixed, while the two seats in the middle fold upwardly to provide floor space for a wheelchair user who rides facing sideways, like other passengers.

The proposed three-seat layout is similar, except that one end seat is eliminated. This leaves one fixed and two folding seats. Regardless of the number of seats, the fact that they face sideways means the armrests provide some degree of restraint in case of an emergency stop. The armrest 66 closest to the center of the vehicle on each fixed seat is optionally hinged at the rear, so the front of the arm rests can be lifted for easier access.

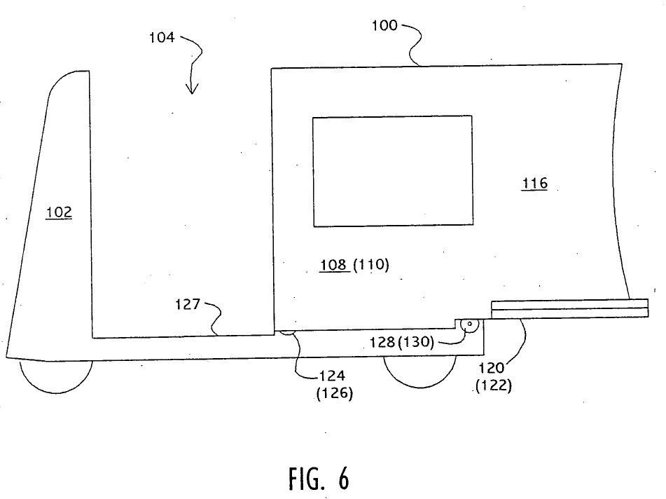

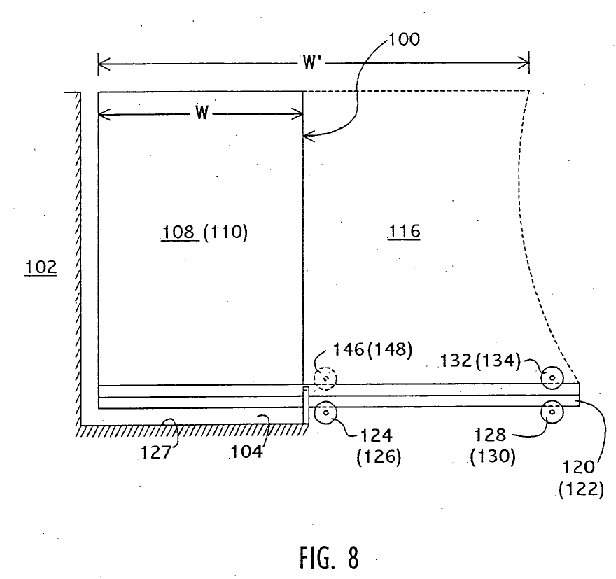

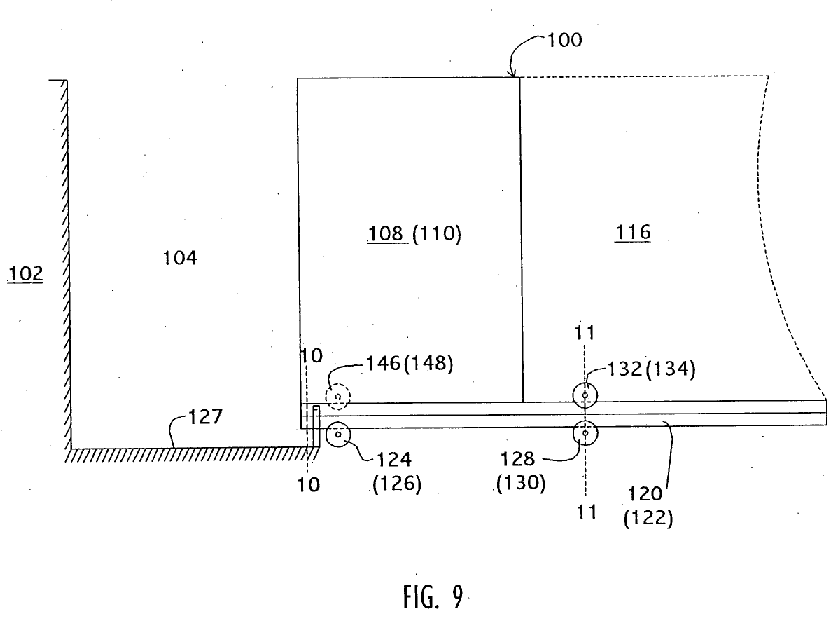

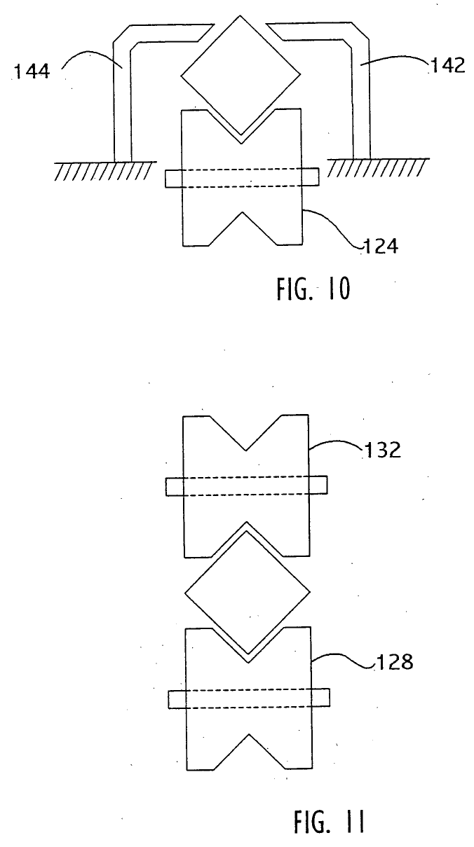

FIGS. 6-12 Cantilevered Canopy for SDPV:

Before considering the cantilevered canopy of FIGS. 6-12, it is helpful to again review the prior art of FIG. 1 wherein it is seen that the opening for boarding or alighting from the PRT vehicle 22 is defined by a roof rail 90 which means that a must stoop beneath the roof rail in order to get from one side of the vehicle to the other when entering into or alighting from the vehicle. This is because the doors 98 and 99 of the prior art vehicle 22 have top portions which are supported on the roof rail.

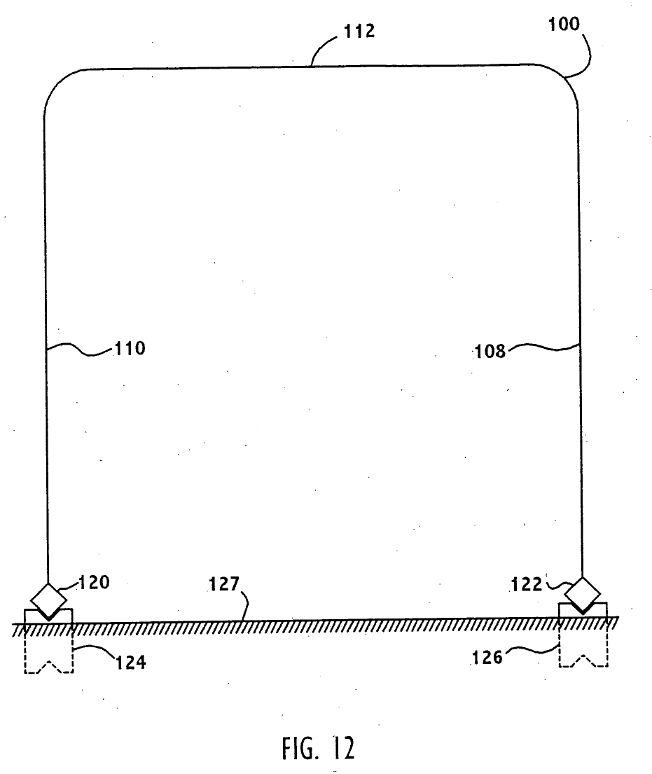

As is seen in FIGS. 6-12, in accordance with the present invention a sliding canopy 100, which is U-shaped in cross section, is slidably mounted on a SDPV 102 having lateral openings 104 therein. As is seen in FIG. 6, the U-shaped canopy 100 has door panels 108 and 110 which are joined by a roof panel 112 (see FIG. 12). Canopy 100 has two versions. In the first version, the canopy 100 has a width W which covers only the opening 104 and in a second version the canopy has a width W′ which provides cover for the entire back part of the vehicle 102 by having an extension 116. The extension 116 negates the need for fixed inner side walls behind the door opening 104.

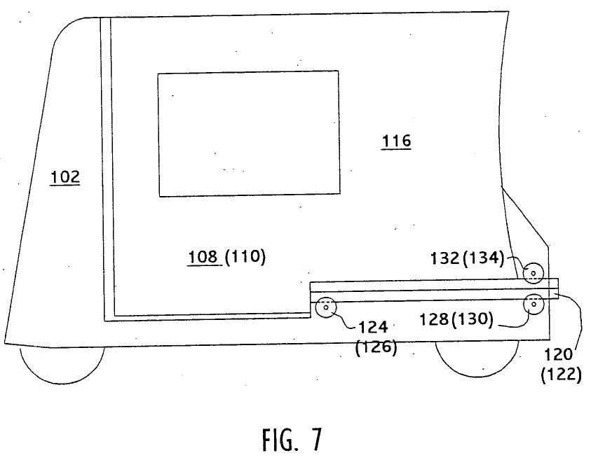

The U-shaped canopy 100 has a pair of diamond-shaped bottom rails 120 and 122 (see FIG. 12). The rails rest in V-shaped grooves in a pair of front rollers 124 and 126 mounted so as to extend just above the floor 127 of the SDPV 102 and in V-shaped grooves in a pair of rear rollers 128 and 130, also mounted to project just above the plane of the floor 127. In order to keep the rails 120 and 122 on the pairs of rollers 124, 126 and 128, 130 a pair of rear upper rollers 132 and 134 are provided just above the rear rollers 128 and 130. Consequently, the U-shaped canopy 100 is prevented from tilting forward on the front rollers 124 and 126 on which the U-shaped canopy is cantilevered. When the U-shaped canopy 100 moves rearwardly from the closed FIG. 7 position to the open FIG. 6 position, it is necessary to make sure that a passenger can not either lift or accidentally bump into the roof panel 112 so as to pivot the canopy upwardly on the rear rollers 128 and 130. This is prevented by two pair of L-shaped brackets 142 and 144 which overlie the diamond shaped rails 120 and 122 adjacent to the front rollers 124 and 126. Alternatively, a front pair of upper rollers 146 and 148 can be employed above the lower rollers 124 and 126 to keep the U-shaped canopy 100 from tilting about the rear rollers 128 and 130. While the aforedescribed arrangement is preferred, other arrangements such as, for example, the double railed arrangements used for desk draws may be employed if it is desirable to have retractable rails when the canopy 100 is closed.

By utilizing the U-shaped canopy 100 as a door 108, or as a door plus a rear panel 116, there is full clearance laterally across the opening 104 of the vehicle 102 so that the passengers don't run the risk of bumping into a ceiling rail.

The cantilevered canopy 100 of FIGS. 6-12 is usable with any seating arrangement, but is especially desirable when used the seating arrangement of FIGS. 2-5 to create more comfortable, passenger-friendly SDPVs.

Shared and Private Operating Systems:

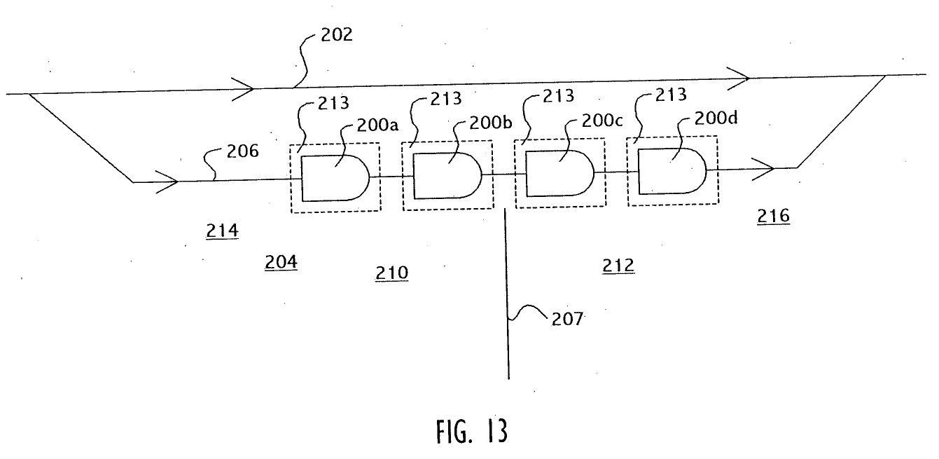

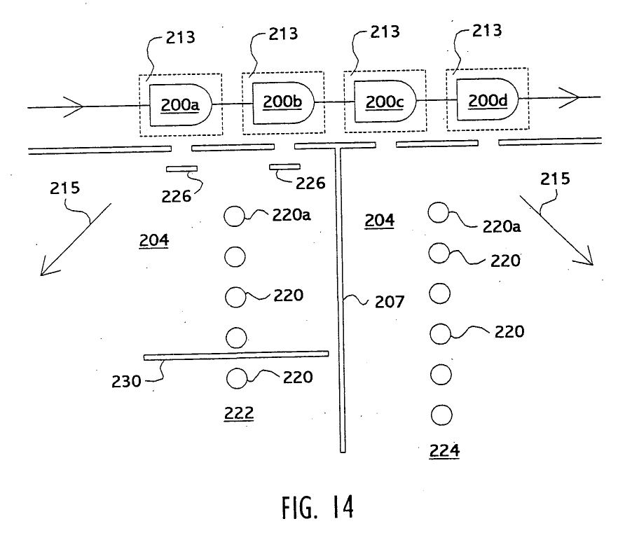

FIGS. 13 and 14:

Referring now to FIGS. 13 and 14, there is shown an arrangement wherein SDPVs 200 traveling a main line 202 stop temporarily at stations 204 accessed by slidings 206. In accordance with the present invention, the station 204 is divided by a barrier 207 into a shared service area 210 and a private service area 212 for boarding and alighting from the SDPV 200. The station 204 also includes a queuing area 214 for arriving vehicles and an optional queuing area 216 for vehicles waiting to merge into the main line 202 (FIG. 13).

If the shared area 210 and the barrier 207 were omitted, the remaining private area 212 would provide the same service as in prior art PRT systems. On the other hand, an alternate realization of the present invention would be to omit the private service area 212 and the barrier 207, and only have a shared service area 210.

Personal Rapid Transit (PRT) Systems generally assume that all of the vehicles 200 are private vehicles, such as the vehicle 22 of FIG. 1, wherein riders hire an entire vehicle and either travel alone or in preformed parties. In the vehicles 200 are automated and have three to four seats but all trips are non-stop from an origin station 204 to a destination station 204. All of the stations 204 are off the main line 202.

In accordance with the present invention, the vehicles are SDP vehicles 200 which still travel non-stop from an origin station 204 to a destination station, but certain vehicles are shared by strangers, particularly during periods of peak demand. The system operator could choose to charge the same fare or a higher fare for private vehicles verses shared ones. If the same fare were charged, a longer queue could be expected for private vehicles. However, passengers desiring a private vehicle would generally have shorter wait times than in an all private system of the prior art. Shared service passengers would have a still shorter wait time.

FIG. 14 shows a SDPV station with four vehicle berths 213a-d for passenger boarding and alighting. Unlike most proposed systems, these stations configured according to the present invention are divided into areas 210 and 212, area 210 being for private service and area 212 being service for shared vehicle service, with each having two berths 213. Other arrangements are possible with different numbers of berths 213. The terms “shared” and “private” apply only to the boarding process. Arriving vehicles 200 in either area can be shared, private or empty.

One rule that is implicit in prior art, all-private PRT operation must be made explicit with shared operation: as is indicated by arrows 215, all arriving passengers must exit their vehicles 200. If they want to continue on, they must go to the end of a queue again. This means all arriving vehicles 200 are equivalent from the point of view of boarding passengers, since they are, or will become, empty.

FIG. 14 shows more details of the passenger area of the same station as in FIG. 13. In FIG. 14, passengers 220 form separate queues 222 and 224 depending on whether they want shared service 210 or private service 212. Passengers 220 are free to choose either queue line 222 or the queue line 224, depending on their personal trade-off between wait time, privacy and optionally willingness to pay a higher fare for private queue line 224.

When a vehicle arrives at a shared berth 213 in the shared service area 210, the first passenger 220a in line selects the destination just before boarding the vehicle. That destination is then displayed over the vehicle entrance, either on the vehicle itself or on a sign 226 fixed above the platform 204. The destination may also be announced verbally for the blind. Others anywhere in line going to the same destination can then board, in line order, up to vehicle capacity. However, it would be impractical to have riders far back in the line boarding the vehicle, since that would delay departure. Thus, there is preferably a point in the shared queue 222 behind which the destination sign is not visible, and additionally a physical deliniation such as is a barrier 230 may be employed which prevents passengers too far back in the line from attempting to board. If there are not enough riders 220 to fill a shared vehicle 200, it leaves anyway, even with one person.

In a large system with, for example, fifty stations 204, it may often happen that there are not enough passengers 220 going to the same destination to fill a vehicle 200. Those near the front of the shared queue would simply wait, knowing that even at one person per vehicle, they would soon be served. However, those farther back (but still able to view the destination sign 226) may chose to leave immediately by boarding a vehicle to a station near their destination. Once there, they can wait for a private SDPV 200 to their final destination.

But why wouldn't they just wait at their origin for a private vehicle 200 in the first place? Consider the trip from Central Business District (CBD) to suburb in the PM peak period. There is heavy demand at all CBD stations with relatively long passenger queues. But in the suburbs, few passengers 220 are boarding while many vehicles 200 are arriving and becoming available. There should be little or no wait for a private vehicle in that case. From the point of view of system efficiency, also, this is beneficial, with the rider traveling most of the distance in a shared vehicle, while making a short hop in a private vehicle.

The SDPV system according to the present invention also helps passengers sort themselves into groups. A large station preferably has several shared boarding areas 222 with each designated for a geographic region, such as for example those stations in the North side of the metro area.

In all cases, the division of vehicle berths 200 into shared and private could be variable by time of day. Shared operation could be limited to AM and PM peak periods, and even if shared mode were offered throughout the day, it could be eliminated during late night hours when demand is very low.

Sharing of small, automated vehicles by strangers involves a trade-off between system capacity and passenger security. A closed circuit TV system is optionally installed in all vehicles and activated whenever any passenger presses a button next to his or her seat. For traditional SDPV applications, such as city CBDs, shared operation might be limited to a few hours during the AM and PM peak demand periods. In applications where crime is not such a concern, such as in some resorts, vehicles could be shared during the day and evening, with private operation limited to late night hours.

Melding of the Inventions of FIGS. 2-5, FIGS. 6-12 and FIGS. 13-14:

The seating stations 40, 42, 50 and 52 are arranged by first conceptually dividing the vehicle floor 32 into front and rear zones 38 and 48 respectively, with each zone being approximately rectangular in shape and running laterally from one side of the vehicle to the other. The vehicle interior consists of four zones (FIGS. 2 and 3) or three zones (FIGS. 4 and 5) positioned one behind the other. Each zone contains one seating station positioned sideways to the direction of travel, as well as open space for the legs of the rider in that seating station. Seats in adjacent zones face in opposite directions. In the four seat arrangement, the seats in the frontmost and rearmost zones are fixed, while the seat cushion, back and armrests of the middle two seats, when not in use, pivot out of their respective zones into the zones of the adjacent fixed seats, thus causing the middle two zones to form a single open area to accommodate a wheelchair. The three seat arrangement is the same as the four seat one, except either the frontmost or rearmost zone is omitted along with its fixed seat.

The operating policy consists of 1) all trips being non-stop from origin to destination, and 2) exclusive or shared use of vehicles depending on time of day, choice of loading birth or other considerations. Riders waiting to board for all destinations are instructed to form a one or more queues each of which serves a loading platform or several closely spaced platforms. If the system is in an exclusive or private mode, the first person in line boards a SDP vehicle 200 and can choose to travel alone or with a pre-formed party. In shared mode: 1) the first person in line selects the destination by pushing a button before entering, and this destination is communicated to others in line by a sign and/or voice announcement, 2) others anywhere in line going to or near that destination can choose to board the vehicle, in line order, and 3) at the destination, all riders must exit and, if they decide to go on, must go to the end of the line again.

Since the vehicle closure is configured as a U-shaped canopy, the doors 108 and 110 on each side of the vehicle and a side-to-side section of the roof 112 move backwards together to allow passenger access and egress, and to allow unobstructed movement within the two zones containing movable seats. The roof section 112 is supported only by the doors 108 and 110, and each door is supported only by the horizontal rail 120 or 122 at its bottom which, when closed, is cantilevered slightly above the entranceway floor. The rails 120 or 122 are each supported by three rollers behind the entranceway, one immediately behind that is below the rod, and two more, one above and one below, located a distance behind the entranceway approximately equal to its width.

The privacy afforded by staggered sideways seats makes the shared use of small vehicles more feasible, while the cantilevered canopy provides easy access to all of these seats. In a typical embodiment of the invention, the opening 104, covered by the U-shaped canopy 100, runs along the lateral edges of two adjacent zones containing folding seat stations. This arrangement lets a wheelchair user access the space in these zones without having to turn within the vehicle, and allows ambulatory riders easy access to both the fixed and folding seating stations.

Each of the three concepts of this invention may be used individually or may be combined with one or two of the other concepts when practicing the invention(s) disclosed herein.

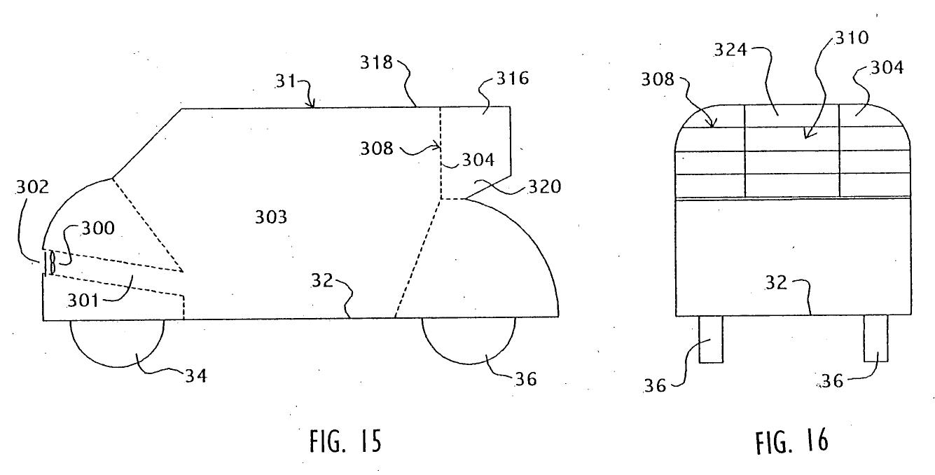

FIGS. 15 and 16 Low Cost, Low Power Ventilation System

Referring now to FIGS. 15 and 16 there is shown a ventilation arrangement for the passenger compartment of a vehicle, such as the vehicle 31 of FIGS. 2-5, in hot weather. This invention arrangement has few mechanical components, thus allowing it to be produced at low cost and requires little power compared to a mechanical air conditioner. It can be incorporated in a SDPV whether or not the improvements shown in FIGS. 2-14 are also incorporated.

Air is drawn in at the front of the vehicle by means of a fan 300 in a duct 301 having an adjustable front cover 302 and/or the forward motion of the vehicle 31. The air then passes through the enclosed space 303 and out a large rear opening 304 of the vehicle. Even if no air is supplied through the duct 301, the large size of the rear opening 304 causes significant circulation within the vehicle 31.

A grille 308 (FIG. 16) covers the rear opening 304 with a mesh 310 small enough to preclude any individual from crawling through, yet large enough to not significantly impede air flow. Even if the grille 308 had a large enough mesh to allow a child to reach through to the outside, the fact that the grille is in the rear of the vehicle 31, rather than the side, reduces the hazard. This is because the child's arm would be extended out over the rear portion of the vehicle, rather than directly away from it. Alternatively, the grille 308 could have a mesh 310 fine enough to prevent even a child's arm from passing through.

An extension 316 of the vehicle's roof 318 and sidewalls 320 extends back from the rear opening 304 to prevent most precipitation from entering the vehicle 31. The forward motion of the vehicle 31 also helps in this regard by tending to counteract any wind that might blow precipitation under the overhang 316 and into the rear opening 304. The length of the extension 316 depends on the expected long term weather pattern at the particular location of the system, including wind intensity and rainfall amount. In some locations, an extension 316 equal in length to the height of the rear opening 304 is satisfactory.

In cold weather, the large rear opening is partially or completely covered by a fixed, transparent sheet 324 which fits over, or in place of, the grille 308. The sheet 324 is installed by system personnel while the vehicle 31 is out of service. The sheet 324 could be installed once a year with the onset of cold weather, or more often in response to temperature variations. Even with the rear opening fully closed, the fan shown in FIG. 15 provides adequate fresh air to the interior space 303 of the vehicle 31.

During both hot and cold weather, the fan 300 and the cover 302 for the air duct 301 are under automatic control, rather than direct passenger control. The control system reads temperature sensors (not shown in FIGS. 15 and 16), and adjusts the air position of the air intake cover 302 and the speed of the fan 300 to keep the temperature in the enclosed space 303 within a comfortable range.

FIGS. 4-7 of the provisional application 60/438,984 filed Jan. 10, 2003 are specifically incorporated herein by reference in their entirety.

From the foregoing description, one skilled in the art can easily ascertain the essential characteristics of this invention, and without departing form the spirit and scope thereof, can make various changes and modifications of the invention to adapt it to various usages and conditions.

I claim:

1. A small driverless passenger vehicle comprising:
a floor having a directional axis, the floor being supported on an array of wheels for conveying the vehicle over a surface;
a canopy disposed above the floor and cooperating with the floor to define an enclosure in which passengers are seated;
a seating arrangement within the enclosure, the seating arrangement having at least three laterally extending seating spaces, and
a single seating station disposed at each seating space for seating a passenger facing laterally with respect to the directional axis of the floor, the seating stations at adjacent seating spaces facing in opposite lateral directions providing unobstructed floor space in front of each seating station and providing a space in the direction of the directional axis between upper bodies of adjacent passengers.

2. The vehicle of claim 1 wherein there are four seating spaces.

3. The vehicle of claim 1 wherein each seating station includes a seat defined by a horizontal surface and wherein at least one of the seats folds to a vertical orientation providing additional floor space.

4. The vehicle of claim 3 wherein the seats of at least two seating stations fold to a vertical orientation.

5. The vehicle of claim 3 wherein there are four seating stations and at least the seats of three seating stations fold to a vertical orientation.

6. The vehicle of claim 5 wherein the seats of all four seating stations fold to a vertical orientation.

7. The vehicle of claim 3 further including horizontal supports for the canopy extending parallel to the directional axis for mounting the canopy to slide from a closed position overlying all of the seating stations to an open position exposing at least seating stations having folding seats.

8. The vehicle in claim 7 wherein the canopy is U-shaped in cross section having leg panels with free edges that are supported on the horizontal supports, the canopy optionally having portions which are transparent and when in the open position allowing ingress and egress from opposite sides of the vehicle.

9. The vehicle of claim 8 wherein the canopy is cantilevered from the rear of the vehicle when in the open position.

10. The vehicle of claim 9 wherein the folding seats provide floor space for wheel chairs, packages, luggage and other items.

11. The vehicle of claim 9 wherein the vehicle includes an upwardly extending rear wall having a vent therethrough.

12. The vehicle of claim 11 wherein the vent is an opening adapted to receive a removable window and/or an optionally removable grill.

13. The vehicle of claim 12 wherein the canopy has an extended portion which extends over and past the opening to shield the opening from precipitation.

14. The vehicle of claim 13 further including an electric fan in the front of the vehicle for generating an air stream through the vehicle.

15. The vehicle of claim 1 in combination with a fleet of similar vehicles with each vehicle providing both shared service and private service, however not at the same time in the same vehicle.

16. The combination of claim 15 further including a main line over which the vehicles travel to carry passengers from one station to another, wherein each station comprises a shared service area for passengers willing to share a ride with strangers; a private service area for passengers deciding not to share rides with strangers; and a vehicle queuing area for arriving vehicles.

17. The vehicle of claim 3 in combination with a fleet of similar vehicles with each vehicle providing both shared service and private service.

18. The combination of claim 16 further including a main line over which the vehicles travel to carry passengers from station to another wherein each station comprises a shared service area for passengers willing to share rider with strangers; a private service area for passengers not deciding to share rides with strangers; and a vehicle queuing area for arriving vehicles.

19. A method of operating a transit system, comprising:
providing a fleet of small driverless passenger vehicles, each vehicle having at least three seating stations which do not directly face one another and which face in alternate directions from opposite sides of the vehicle;
providing a transportation line heaving at least two stations from which the vehicles start and stop when carrying passengers therebetween;
queuing passengers who are willing to share rides with other passengers in at least one line at a shared service location;
queuing passengers who prefer not sharing rides with strangers in at least one line at a private service location.

20. The method of claim 19 wherein there are a number of stations, and wherein when any one of the vehicles arrives at a shared service area at one of the stations, all riding passengers exit the vehicle and the first waiting passenger in the line selects a designation just prior to entering the vehicle; the method further including notifying other passengers in the line of the selected destination and advancing passengers in the line going to the selected destination past passengers going to other destinations for boarding the vehicle to the destination selected by the first waiting passenger.

21. The method of claim 20 further including dividing the line into front and rear sections and notifying only those in the front section of an available seat for the selected destination.

22. The method of claim 21 wherein other passengers in the shared service line exercise the option to enter the vehicle even if the destination selected by the first waiting passenger is an initial destination, rather than a desired destination of other passengers, and wherein upon arrival at the initial destination the other passengers exercise the option of then boarding either a vehicle in the private service area or the shared service area to take another vehicle to their desired destination.
